(19) United States
(12) Patent Application Publication
(10) Pub. No.: US 2008/0007178 A1
(43) Pub. Date: Jan. 10, 2008

(54) Metal Halide Lamp and Illuminating Device Using the Same

(75) Inventors: Atsushi Utsubo, Osaka (JP); Hiroshi Nohara, Hyogo (JP); Ryo Minamihata, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi, Osaka, JP (JP)

(21) Appl. No.: 11/574,770

(22) PCT Filed: Sep. 7, 2005
(86) PCT No.: PCT/JP05/16391

§ 371 Date: Mar. 6, 2007

(30) Foreign Application Priority Data
Sep. 10, 2004 (JP) 2004-263625

(51) Int. Cl. H01J 61/30

(52) U.S. Cl. 313/634

(57) ABSTRACT

A metal halide lamp according to the present invention includes a discharge tube (3) having an envelope (18) that is formed of a translucent ceramic and has a main tube portion (16), a first slender tube portion (17a) and a second slender tube portion (17b) respectively formed in both end portions of this main tube portion (16), and a first electrode lead-in member (21) and a second electrode lead-in member (22) having a first electrode portion (25a) and a second electrode portion (25b) formed in their respective tip portions. The individual electrode lead-in members (21, 22) are inserted in the respective slender tube portions (17a, 17b), and a gap (23) is formed respectively between the slender tube portion (17a, 17b) and the electrode lead-in member (21, 22). A proximity conductor (19) is provided on an outer surface of the discharge tube (3), at least 2 turns of part of the proximity conductor (19) are wound helically around an end portion of the first slender tube portion (17a) on a side of the main tube portion (16). The proximity conductor (19) is connected electrically to the second electrode portion (25b). An amount of sealed mercury in the discharge tube (3) is equal to or smaller than 2.5 mg/cm³. The restarting characteristics are improved considerably.

### TECHNICAL FIELD

The present invention relates to a metal halide lamp and an illuminating device using the same.

### BACKGROUND ART

In metal halide lamps that have been used conventionally as, for example, indoor and outdoor illumination of a store, a sports arena, etc., in particular metal halide lamps whose discharge tube envelope is formed of a translucent ceramic material (in the following, referred to as a “ceramic metal halide lamp”), those in which a proximity conductor is disposed so as to be in proximity or contact with its discharge tube for the purpose of shortening the time required for starting and restarting have been known (see Patent document 1, for example).

In particular, by winding an end portion of this proximity conductor around a slender tube portion of the discharge tube, the proximity conductor is capacitively coupled to an electrode lead-in member via the slender tube portion at the time of starting, so that a dielectric breakdown occurs in a gap formed between the slender tube portion and the electrode lead-in member, thus generating initial electrons. Also, this dielectric breakdown generates ultraviolet rays, and the ultraviolet radiation causes molecules present in a main tube portion to be excited, thus generating initial electrons. Then, due to these initial electrons, an electron avalanche occurs between electrodes, so that a discharge is started. In this way, the dielectric breakdown between the electrodes is facilitated, thereby allowing start-up even with a low pulse voltage such as a maximum pulse voltage (a peak voltage) of 2.5 kV and reducing the time required for restarting down to 5 minutes or less.

In these kinds of ceramic metal halide lamps, at least 10 mg/cm³ of mercury usually is sealed as a buffer gas so that the lamp voltage during a stable operation is approximately 90 V.

Recently, a ceramic metal halide lamp has been suggested to have a discharge tube in which cerium iodide (CeI₃) and sodium iodide (NaI) are sealed and that has an elongated shape (satisfying L/D>5, where D represents an inner diameter of the discharge tube and L represents the distance between electrodes) in order to achieve a higher efficiency (see Patent document 2, for example). This ceramic metal halide lamp is said to achieve an extremely high discharge efficiency of 111 to 177 LPW (=lm/W). Moreover, in this ceramic metal halide lamp, since the discharge tube has an elongated shape, the amount of mercury to be sealed therein may be smaller than usual, for example, 0.7 mg (<1.6 mg/cm³) in the case of a rated lamp power of 150 W to achieve a lamp voltage of 80 to 100 V. Thus, there is an advantage in that this lamp is friendly with the environment.

Patent document 1: JP 10(1998)-294085 A

Patent document 2: JP 2000-501563 A

### DISCLOSURE OF INVENTION

### Problem to be Solved by the Invention

As described above, in the conventional ceramic metal halide lamp, the slender tube portion of the discharge tube is provided with the proximity conductor for assisting start-up, whereby restarting characteristics have been improving, but still it sometimes takes as long as 5 minutes to restart the lamp. This causes the following problem. For example, in a facility using the conventional ceramic metal halide lamp, when an unexpected power failure occurs, an auxiliary halogen lamp or the like is lit up as a safety lamp in preparation for any safety-related contingency until the ceramic metal halide lamp serving as a main lamp restarts.

Accordingly, there has been a demand for further improvement in the restarting characteristics in the market. However, at the moment, a practical technology for shortening the restarting time considerably has not been found and is considered to be difficult.

The present invention provides a breakthrough for such a situation, and it is an object of the present invention to provide a metal halide lamp capable of improving restarting characteristics considerably and an illuminating device using the same.

### Means for Solving Problem

A metal halide lamp according to the present invention includes a discharge tube including an envelope that is formed of a translucent ceramic and has a main tube portion and a first slender tube portion and a second slender tube portion respectively formed in both end portions of the main tube portion, a first electrode lead-in member having a first electrode portion formed in its tip portion, and a second electrode lead-in member having a second electrode portion formed in its tip portion. The first electrode lead-in member is inserted in the first slender tube portion so that a tip portion of the first electrode portion is located in the main tube portion, and the first electrode lead-in member is sealed in an end portion of the first slender tube portion on a side opposite to the main tube portion. The second electrode lead-in member is inserted in the second slender tube portion so that a tip portion of the second electrode portion is located in the main tube portion, and the second electrode lead-in member is sealed in an end portion of the second slender tube portion on a side opposite to the main tube portion. A gap is formed between the slender tube portion and the electrode lead-in member. A proximity conductor is provided on an outer surface of the discharge tube, at least 2 turns of part of the proximity conductor are wound helically around an end portion of the first slender tube portion on a side of the main tube portion, and the proximity conductor is connected electrically to the second electrode portion. An amount of sealed mercury in the discharge tube is equal to or smaller than 2.5 mg/cm³.

### Effects of the Invention

With the metal halide lamp according to the present invention, at least 2 turns of part of the proximity conductor that is connected electrically to the second electrode portion are wound helically around an end portion of the first slender tube portion, and the amount of sealed mercury in the discharge tube is equal to or smaller than 2.5 mg/cm³, so that the restarting characteristics improve considerably.

### BRIEF DESCRIPTION OF DRAWINGS

FIG. 1 is a partially broken front view showing a metal halide lamp in Embodiment 1 of the present invention.

FIG. 2 is a front view showing a discharge tube used in the same metal halide lamp.

FIG. 3 is a front sectional view showing the discharge tube used in the same metal halide lamp.

FIG. 4 shows the relationship between an amount of sealed mercury (mg/cm³) and an average restarting time (minutes).

FIG. 5 is an enlarged sectional view showing a main portion of a discharge tube used in a metal halide lamp in Embodiment 2 of the present invention.

FIG. 6 is a front view showing the discharge tube used in the same metal halide lamp.

FIG. 7 is a partially broken front view showing an illuminating device in Embodiment 3 of the present invention.

### EXPLANATION OF LETTERS OR NUMERALS

1 Metal halide lamp
2 Outer tube
3 Discharge tube
4 Lamp base
5 Flare
6, 7 Stems
8 Power supply line
9, 10 External lead wires
11 Eyelet portion
12 Shell portion
13 Barium getter
14 Cylindrical portion
15 Hemispherical portion
16 Main tube portion
17a First slender tube portion
17b Second slender tube portion
18 Envelope
19 Proximity conductor
19a First helical portion
20 Resistor
21 First electrode lead-in member
22 Second electrode lead-in member
23 Gap
24 Glass frit
25a First electrode portion
25b Second electrode portion
26a, 26b Internal lead wires
27a, 27b Electrode axial portions
28a, 28b Coils
29a, 29b Electrode coil portions
30 Ceiling
31 Reflecting lighting fixture
32 Base portion
33 Socket portion
34 Luminaire
Electronic ballast

### DESCRIPTION OF THE INVENTION

In the metal halide lamp according to the present invention, it is preferable that at least 0.5 turn of the proximity conductor is wound helically around an outer surface of the main tube portion over an entire end region of the main tube portion sandwiched by a second plane and a third plane, where a first plane is defined as a plane that includes a tip of the first electrode portion and is orthogonal to a center axis of the discharge tube in its longitudinal direction, the second plane is defined as a plane that is parallel with the first plane and spaced by 5 mm from the first plane toward the second electrode portion, and the third plane is defined as a plane that is parallel with the first plane and, in a cross-section of the discharge tube taken along a plane including the center axis, includes a point of change at which a straight line portion of an inner surface of the first slender tube portion extending from an end opposite to the main tube portion out of both ends of the first slender tube portion toward the main tube portion changes to another straight line or a curve.

An illuminating device according to the present invention includes a luminaire, and the metal halide lamp that has any of the above-described configurations and is built into the luminaire.

The following is a description of preferred embodiments of the present invention, with reference to the accompanying drawings.

### EMBODIMENT 1

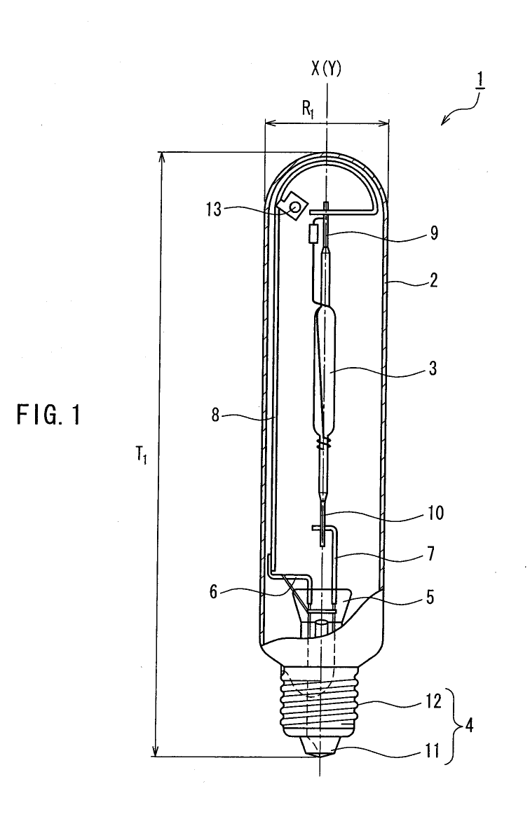

FIG. 1 is a sectional view showing a metal halide lamp in Embodiment 1 of the present invention. This metal halide lamp 1 is a ceramic metal halide lamp with a rated lamp power of 150 W, has a total length T₁ of 175 to 185 mm, for example, 180 mm, and includes an outer tube 2, a discharge tube 3 disposed in this outer tube 2 and a screw-type lamp base (an E lamp base) 4 fixed firmly to an end portion of the outer tube 2.

A center axis of the discharge tube 3 in its longitudinal direction (indicated by X in FIG. 1) substantially coincides with a center axis of the outer tube 2 in its longitudinal direction (indicated by Y in FIG. 1).

The outer tube 2 is formed of, for example, a substantially cylindrical hard glass or the like with an outer diameter R₁ of 25 to 55 mm, for example, 40 mm. One end portion of the outer tube 2 is closed in a hemispherical manner, and a flare 5 formed of, for example, borosilicate glass is sealed in the other end portion.

The inside of the outer tube 2, namely a sealed space in which the discharge tube 3 is disposed, is maintained under vacuum at an air pressure of equal to or lower than 1×10¹ Pa, for example, 1×10⁻¹ Pa at 300 K. By setting the degree of vacuum inside the outer tube 2 to equal to or lower than 1×10¹ Pa at 300 K as mentioned above, it is possible to suppress transmission of heat in the discharge tube 3 via a gas in that space to the outer tube 2 and discharge thereof to an outside. This prevents a decline in discharge efficiency due to heat loss. On the other hand, when the degree of vacuum in the outer tube 2 exceeds 1×10¹ Pa at 300 K, the heat in the discharge tube 3 becomes likely to be transmitted via the gas in that space to the outer tube 2 and discharged to the outside. Thus, the discharge efficiency may decline due to heat loss.

Each of two stems 6 and 7 formed of nickel or mild steel, for example, is sealed partially in the flare 5. One end portion of each of the two stems 6 and 7 is led in the outer tube 2. One stem 6 is connected electrically via a power supply line 8 to one external lead wire 9 that is led out from the discharge tube 3. The other stem 7 directly is connected electrically to the other external lead wire 10. The discharge tube 3 is supported inside the outer tube 2 by these two stems 6 and 7 and the power supply line 8. Further, the other end portion of the stem 6 is connected electrically to an eyelet portion 11 of the lamp base 4, and the other end portion of the stem 7 is connected electrically to a shell portion 12 of the lamp base 4. The stems 6 and 7 are made of a single metal wire formed by welding and integrating a plurality of metal wires.

The power supply line 8 extends linearly from the vicinity of the flare 5 to a side of the closed portion of the outer tube 2 along an inner shape of the outer tube 2, is bent substantially semi-circularly along the inner shape of the closed portion of the outer tube 2, further is bent toward the center axis Y of the outer tube 2 in the longitudinal direction so as to cross the external lead wire 9 at a substantially right angle, and then extends straight. Additionally, a barium getter 13 is attached to a portion of the power supply line 8 located on the side of the closed portion of the outer tube 2.

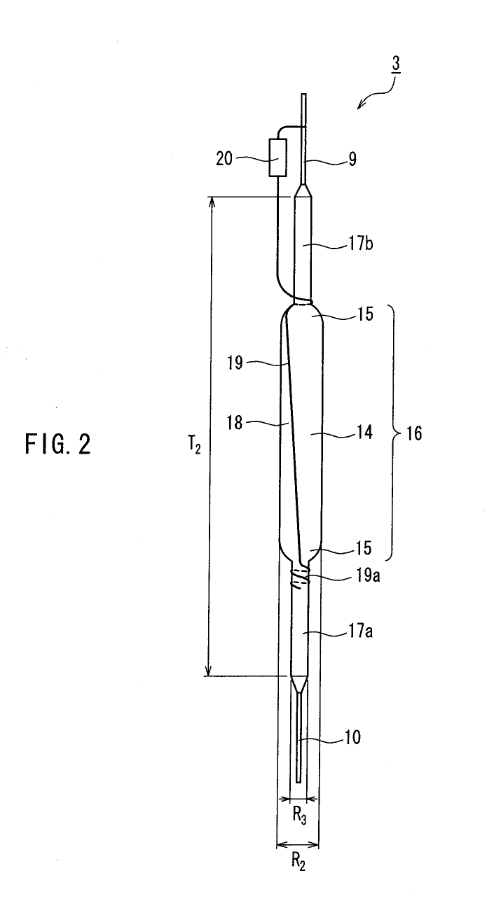

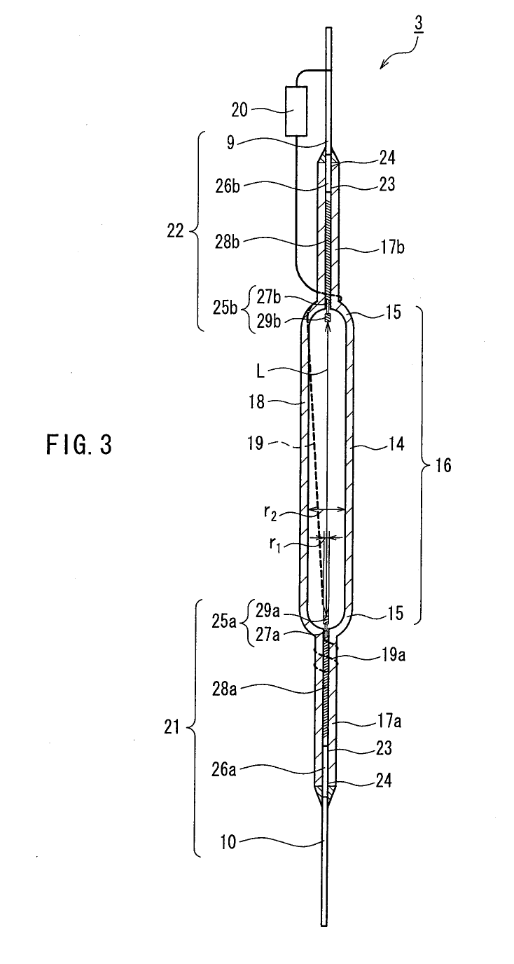

As shown in FIG. 2, the discharge tube 3 has an envelope 18 that is formed of polycrystalline alumina and includes a main tube portion 16 with a cylindrical portion 14 and hemispherical portions 15 connected to both end portions of this cylindrical portion 14, and a first slender tube portion 17a and a second slender tube portion 17b that are connected to the hemispherical portions 15. The discharge tube 3 has a total length T₂ (the length combining the main tube portion 16, the first slender tube portion 17a and the second slender tube portion 17b) of 60 to 85 mm, for example, 71 mm. The cylindrical portion 14 has an outer diameter R₂ of 4.5 to 8.0 mm, for example, 6.4 mm and an inner diameter r₁ (see FIG. 3) of 2.5 to 6.0 mm, for example, 4.0 mm. The first slender tube portion 17a and the second slender tube portion 17b have an outer diameter R₃ of 2.5 to 4.0 mm, for example, 3.2 mm and an inner diameter r₂ (see FIG. 3) of 0.8 to 1.2 mm, for example, 1.0 mm. The envelope 18 has an inner volume (except for the slender tube portions 17a and 17b) of 0.16 to 0.85 cm³, for example, 0.435 cm³.

The material for the envelope 18 of the discharge tube 3 can be not only polycrystalline alumina but also translucent ceramic such as yttrium-aluminum-garnet (YAG), aluminum nitride, yttria or zirconia. Also, the example illustrated in FIG. 2 uses the envelope 18 whose constituent portions are integrally-molded seamlessly. However, there is no particular limitation to this, and individual members also may be formed in one piece by shrink fitting the slender tube portions 17a and 17b molded in a separate step to the hemispherical portions 15 of the main tube portion 16, for example.

Further, a metal halide formed of, for example, praseodymium iodide (PrI₃) and sodium iodide (NaI) as a discharge material, mercury as a buffer gas and a xenon (Xe) gas as an auxiliary starting gas are sealed in the discharge tube 3. The total amount of the metal halide is 5.5 to 19 mg, for example, 9 mg, and the metal halide is sealed so that the mole ratio of the respective components is, for example, 1:8. The mercury is sealed in an amount equal to or smaller than 2.5 mg/cm³. The amount of sealed mercury is adjusted suitably within the range equal to or smaller than 2.5 mg/cm³ so as to obtain a desired lamp voltage during operation. In some cases, however, no mercury (0.0 mg/cm³) may be sealed by adjusting the sealed materials using a known means. The xenon gas is sealed so as to be 25 kPa at 300 K.

Incidentally, in order to obtain an initial lamp voltage (up to 100 hours of operation) of 80 to 100 V in the range where the amount of sealed mercury is equal to or smaller than 2.5 mg/cm³, it is preferable that r₁ (see FIG. 3) and L (see FIG. 3) satisfy 6≦r₁/L≦10 regardless of the rated power.

As the discharge material, instead of the combination of praseodymium iodide and sodium iodide, it also is possible to use various known metal iodides such as the combination of cerium iodide (CeI₃) and sodium iodide and the combination of a rare-earth metal iodide such as dysprosium iodide (DyI₃), thulium iodide (TmI₃) or holmium iodide (HoI₃) and thallium iodide (TlI) and sodium iodide often used for a high color rendition ceramic metal halide lamp, according to desired color characteristics. The whole or part of the iodide can be replaced by bromide. As the auxiliary starting gas, instead of the xenon gas, it also is possible to use an argon (Ar) gas, a krypton (Kr) gas or a mixed gas thereof.

Further, a proximity conductor 19 for assisting starting made of 0.2 mm molybdenum wire, for example, is disposed so as to contact an outer surface of the discharge tube 3. In other words, at least 2 turns of the proximity conductor 19 first are wound helically around an end portion of the outer surface of the first slender tube portion 17a on the side of the main tube portion 16 so as to be in close contact with the end portion. In the example illustrated in FIG. 2, 2 turns of the proximity conductor 19 are wound around an entire region of the outer surface of the first slender tube portion 17a extending 2 mm from the end on the side of the main tube portion 16. Furthermore, the proximity conductor 19 is disposed along the longitudinal direction of the discharge tube 3 so as to run vertically through the main tube portion 16, namely, disposed so as to be in close contact with the outer surface of the main tube portion 16 without being wound around the main tube portion 16 substantially. Moreover, about 0.8 turn of the proximity conductor 19 is wound helically around the end portion of the outer surface of the second slender tube portion 17b on the side of the main tube portion 16. Finally, the proximity conductor 19 is connected electrically to the external lead wire 9 via a resistor 20. Thus, this proximity conductor 19 is at an equal potential with a second electrode portion 25b (an electrode lead-in member 22) shown in FIG. 3 later. Also, a first helical portion 19a of the proximity conductor 19 wound around the first slender tube portion 17a is in proximity with a first electrode portion 25a described below that is opposite to this proximity conductor 19 in polarity.

It is preferable that the molybdenum wire used as the proximity conductor 19 has a wire diameter of 0.1 to 0.3 mm in order to be worked easily into a helical shape, maintain the helical shape stably and suppress a decrease in light flux or deterioration of light distribution characteristics due to the shadow of the wire. If the wire diameter is smaller than 0.1 mm, it may be difficult to work the wire into the helical shape and stabilize it. On the other hand, if the wire diameter exceeds 0.3 mm, the shadow of the proximity conductor 19 becomes noticeable even by a visual observation during lamp operation, so that the light flux may decrease or the light distribution characteristics may be deteriorated.

Now, a “coiling pitch” of the first helical portion 19a will be described. The “coiling pitch” is a value, expressed by %, of the ratio of the distance between centers of a pair of adjacent turns of the coil with respect to the wire diameter (diameter) of the molybdenum wire serving as the proximity conductor 19. Accordingly, the coiling pitch of 100% means that the adjacent turns contact each other. In the first helical portion 19a, no problem arises as long as the adjacent turns at least do not contact each other, in other words, the coiling pitch is not 100%. However, in order to prevent reliably the adjacent turns from contacting each other due to deformation caused by a heat cycle between turning on and off, it is preferable that the coiling pitch is equal to or larger than 150%. If the coiling pitch is smaller than 150%, the adjacent turns may contact each other due to deformation gradually caused by the heat cycle between turning on and off. On the other hand, if the coiling pitch is excessively large, the first helical portion 19a cannot be disposed locally in the end portion of the first slender tube portion 17a on the side of the main tube portion 16. Thus, it is preferable that the coiling pitch is equal to or smaller than 1000%.

Incidentally, since an open molybdenum wire is used in the example illustrated above, the adjacent turns are disposed so as not to contact each other. However, if this molybdenum wire is coated with a known insulating member, the adjacent turns may contact each other.

Part of the proximity conductor 19 is wound around the second slender tube portion 17b in order to hold the proximity conductor 19 so as not to be detached from the discharge tube 3 while keeping it in close contact with the discharge tube 3. Thus, it is not always necessary to wind the proximity conductor 19 around the second slender tube portion 17b in terms of the restarting characteristics, but it is more appropriate to wind a plurality of turns of the proximity conductor 19 in terms of secure holding. Also, as described above, the proximity conductor 19 is not wound substantially around the main tube portion 16. In other words, after being wound around the first slender tube portion 17a, 0.1 turn of the proximity conductor 19 is not intentionally but practically wound around the entire region of the main tube portion 16 so that the proximity conductor 19 can be wound around the second slender tube portion 17b without being subjected to any special processing.

It should be noted that the material of the proximity conductor 19 can be not only molybdenum but also tungsten (W), platinum (Pt), gold (Au) or an alloy thereof.

Also, “close contact” here includes not only the case where the proximity conductor 19 completely is in close contact with the outer surface of the discharge tube 3 in a strict sense but also the case where it partially and inevitably is spaced from the outer surface of the discharge tube 3.

The resistor 20 prevents an anomalous discharge between the proximity conductor 19 and a member opposite thereto in polarity, for example, the external lead wire 10 when the lamp is not in use, and is set to have a resistance of 10 to 100 kΩ, for example, 20 kΩ.

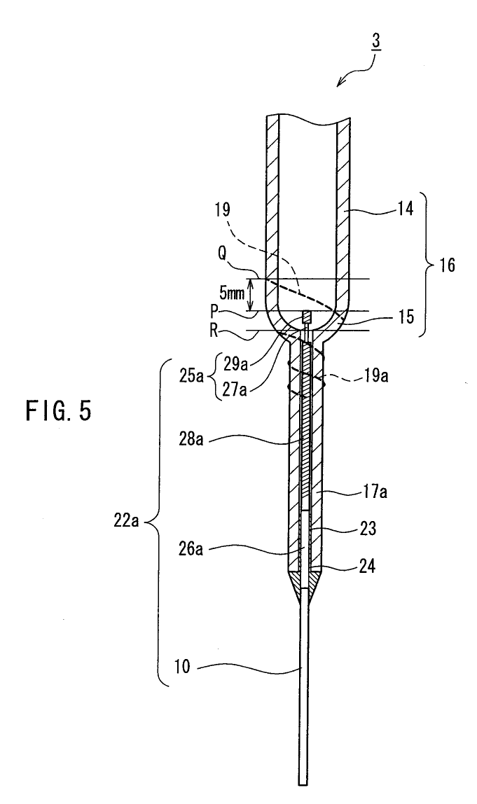

As shown in FIG. 3, the first electrode lead-in member 21 is inserted in the first slender tube portion 17a, and the second electrode lead-in member 22 is inserted in the second slender tube portion 17b. The electrode lead-in members 21 and 22 respectively are sealed in the end portions opposite to the main tube portion 16 by a glass frit 24 filled in gaps 23 between the slender tube portion 17a and the electrode lead-in member 21 and between the slender tube portion 17b and the electrode lead-in member 22, respectively. A detailed structure of this part is shown in FIG. 5, which illustrates Embodiment 2.

The first electrode lead-in member 21 has the first electrode portion 25a formed in its tip portion, an internal lead wire 26a whose one end portion is connected to this electrode portion 25a, the external lead wire 10 whose one end portion is connected to the internal lead wire 26a and a coil 28a. The internal lead wire 26a is formed of an electrically conductive cermet obtained by sintering aluminum oxide (Al₂O₃) and molybdenum (Mo), for example, and has a diameter of 0.9 mm, for example. The external lead wire 10 is formed of niobium, for example. The coil 28a is wound around part of an electrode axial portion 27a, which will be described later, of the first electrode portion 25a and formed of molybdenum having a wire diameter of 0.2 mm, for example.

On the other hand, likewise, the second electrode lead-in member 22 has a first electrode portion 25b formed in its tip portion, an internal lead wire 26b whose one end portion is connected to this electrode portion 25b, the external lead wire 9 whose one end portion is connected to the internal lead wire 26b and a coil 28b. The internal lead wire 26b is formed of an electrically conductive cermet obtained by sintering aluminum oxide (Al₂O₃) and molybdenum (Mo), for example, and has a diameter of 0.9 mm, for example. The external lead wire 9 is formed of niobium, for example. The coil 28b is wound around part of an electrode axial portion 27b, which will be described later, of the first electrode portion 25b and formed of molybdenum having a wire diameter of 0.2 mm, for example.

Therefore, in the case where the slender tube portions 17a and 17b have an inner diameter r₂ of, for example, 1.0 mm, the respective electrode lead-in members 21 and 22 have a maximum outer diameter (including the coils 28a and 28b) of 1.3 mm. Thus, an average gap of 0.1 mm is formed between the respective slender tube portions 17a and 17b and the electrode lead-in members 21 and 22. This gap makes it possible to insert the electrode lead-in members 21 and 22 into the respective slender tube portions 17a and 17b with allowance. However, owing to their processing, the respective electrode lead-in members 21 and 22 often are sealed at positions shifted from the center axis (located on the same axis as the center axis X) of the slender tube portions 17a and 17b in their longitudinal direction.

The electrode portions 25a and 25b have the electrode axial portions 27a and 27b formed of, for example, 0.5 mm diameter tungsten and electrode coil portions 29a and 29b attached to the tip portions of the electrode axial portions 27a and 27b. The tips of these two electrode portions 25a and 25b substantially are opposed to each other. The distance L between the electrode portions 25a and 25b is set to 24 to 40 mm, for example, 32 mm.

End portions of the internal lead wires 26a and 26b on the side opposite to the electrode axial portions 27a and 27b are led from the end portions of the respective slender tube portions 17a and 17b to the outside and connected electrically via the external lead wires 10 and 9 to the stem 7 and the power supply line 8, respectively, as described above.

The coils 28a and 28b respectively fill the gaps between the slender tube portion 17a and the electrode axial portion 27a and between the slender tube portion 17b and the electrode axial portion 27b as much as possible, thereby suppressing the sinking of the liquid metal halide into the gaps.

Incidentally, instead of the electrode lead-in members 21 and 22 constituted by the electrode portions 25a and 25b formed of tungsten, the internal lead wires 26a and 26b formed of electrically conductive cermet, the external lead wires 10 and 9 formed of niobium and the coils 28a and 28b formed of molybdenum, electrode lead-in members with known material and structure can be used.

The above-described metal halide lamp 1 is lit up by, for example, an electronic ballast (not shown in the figure) as described below.

That is, the electronic ballast used as an example applies a square wave voltage at a frequency of 165 Hz during normal operation and applies a maximum 3.5 kV of high frequency voltage at a frequency of about 100 kHz by LC resonance in cycles of ON (0.1 second) and OFF (0.9 second) for 30 seconds at the time of starting and restarting. In the case where the metal halide lamp 1 does not start within 30 seconds, after 2 minutes of pause, the above-mentioned high frequency voltage application for 30 seconds is repeated at 2-minute intervals for 30 minutes. In the case where the metal halide lamp 1 does not start even after 30 minutes, the electronic ballast stops its output.

Here, the function of the proximity conductor 19 at the time of starting and restarting will be described.

At the time of starting and restarting, the first helical portion 19a of the proximity conductor 19 has an equal potential with the second electrode portion 25b because the opposite end portion thereof is connected electrically to the external lead wire 9. Thus, the first helical portion 19a is opposite to the first electrode portion 25a in polarity. Further, polycrystalline alumina constituting the first slender tube portion 17a also functions as a dielectric. Accordingly, the first helical portion 19a of the proximity conductor 19 is capacitively coupled to the first electrode lead-in member 21 via the first slender tube portion 17a at the time of starting and restarting. In other words, when the proximity conductor 19 is, for example, at a positive potential, the electrode axial portion 27a and the coil 28a are at a negative potential. Thus, the outer surface side of the first slender tube portion 17a is negatively charged, and the inner surface side of the first slender tube portion 17a opposite thereto is positively charged. As a result, at the time of starting and restarting, first, the dielectric breakdown occurs in the gap formed between the inner surface of the first slender tube portion 17a and the electrode axial portion 27a or the coil 28a, and a minute discharge occurs. This generates initial electrons and irradiates ultraviolet rays. Also, this ultraviolet radiation causes molecules present in the main tube portion 16 to be excited, thus generating initial electrons. On the other hand, the portion of the proximity conductor 19 located in the end portion of the main tube portion 16 on the side of the first slender tube portion 17a also is capacitively coupled to the first electrode portion 25a via the main tube portion 16. Thus, in the end portion of the main tube portion 16 on the side of the first slender tube portion 17a, the initial electrons induce the dielectric breakdown between the proximity conductor 19 and the first electrode portion 25a via the main tube portion 16, thereby generating an arc discharge. This facilitates an ionization process toward the dielectric breakdown between the electrode portions 25a and 25b, so that a short time starting becomes possible even with a low starting voltage or a low restarting voltage.

The following description will be directed to results of an experiment conducted for confirming an effect produced by the configuration of the metal halide lamp 1 with a rated lamp power 150 W according to the present embodiment.

Lamps were produced by varying the amount of sealed mercury and the number of turns of the first helical portion 19a of the proximity conductor 19 as shown in Table 1 in the metal halide lamp 1 with the above-described configuration. In other words, by varying the amount of sealed mercury in the range of 1.0 to 5.0 mg/cm³ and varying the number of turns of the first helical portion 19a among 1, 2 and 4, 10 lamps for each condition were produced. Then, after individual lamps produced as above were operated continuously for 1 hour by a usual method using the above-mentioned electronic ballast, they were turned off and restarted. The restarting time from immediately after turning off (a power) until restarting was measured. Incidentally, the “restarting” here refers to the state when the arc discharge started after turning on the power.

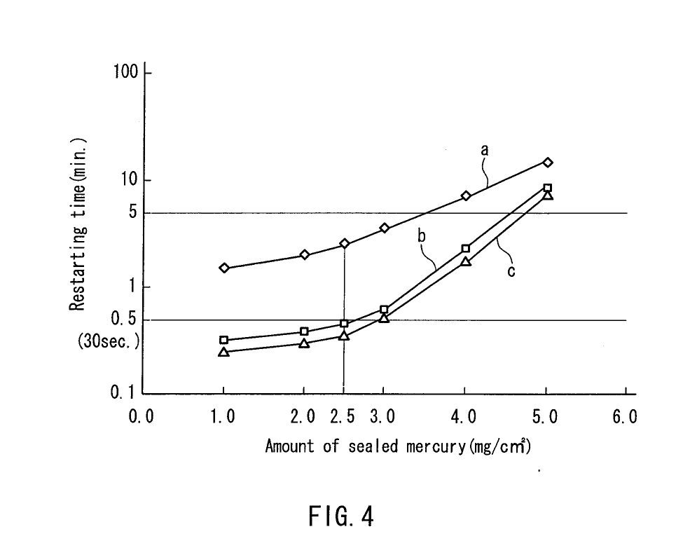

The obtained result was shown in Table 1 and FIG. 4. FIG. 4 is shown as a semi-log graph. In FIG. 4, a “solid line a” indicates the case in which the number of turns of the first helical portion 19a is 1, a “solid line b” indicates the case in which the number of turns of the first helical portion 19a is 2, and a “solid line c” indicates the case in which the number of turns of the first helical portion 19a is 4. The “restarting time” is an average of 10 samples.

TABLE 1

| Amount of sealed | Average restarting time (min.) | | |
|---|---|---|---|
| mercury (mg/cm³) | 1 turn | 2 turns | 4 turns |
| 1.0 | 1.50 | 0.32 | 0.25 |
| 2.0 | 2.00 | 0.38 | 0.30 |
| 2.5 | 2.50 | 0.45 | 0.35 |
| 3.0 | 3.50 | 0.60 | 0.50 |
| 4.0 | 7.00 | 2.20 | 1.70 |
| 5.0 | 14.00 | 8.00 | 7.00 |

As becomes clear from Table 1 and FIG. 4, in the cases where the number of turns of the first helical portion 19a was 2 or more, for example, 2 and 4, the average restarting time became remarkably shorter with a decrease in the amount of sealed mercury compared with the case where the number of turns thereof was 1. When the amount of sealed mercury was equal to or smaller than 2.5 mg/cm³, a surprising result of 30 seconds or shorter (which was 1/10 or less compared with the conventional ceramic metal halide lamp [see Patent document 1]) was obtained.

It should be noted that the shortest restarting time of the samples with an amount of sealed mercury of 2.5 mg/cm³ and the number of turns of the first helical portion 19a of 2 was 1.0 second.

As described above, it was confirmed that the configuration of the metal halide lamp 1 with a rated lamp power of 150 W according to Embodiment 1 of the present invention made it possible to improve the restarting characteristics considerably. Incidentally, it was confirmed that the result shown in Table 1 also was obtained even in the case of applying a high frequency voltage of 3.0 kV maximum, for example. Thus, at least by applying a high frequency voltage of 3.0 kV maximum, the above-described effect is considered to be obtainable reliably. However, as the high frequency voltage to be applied becomes larger, the restarting characteristics are considered to improve further.

The reason is considered to be that, since the number of turns of the first helical portion 19a is set to 2 or more, it is possible to intensify the minute discharge generated in the gap between the inner surface of the first slender tube portion 17a and the electrode axial portion 27a or the coil 28a at the time of restarting and to enlarge a region in which the minute discharge is generated, so that the number of initial electrons to be supplied in the main tube portion 16 and the amount of ultraviolet radiation can be increased. In addition to this, it is possible to reduce a vapor pressure of the mercury, so that at the time of restarting the energies of the initial electrons and secondary electrons in the main tube portion 16 can be raised by the application of the restarting voltage. In other words, since the number of mercury atoms in the main tube portion 16 is small, the individual electrons are less likely to collide with the mercury atoms before being accelerated, and thus can obtain a sufficient kinetic energy. Consequently, it is considered that the ionization process toward the dielectric breakdown between the electrode portions 25a and 25b is facilitated further, thereby shortening the restarting time to equal to or shorter than 30 seconds.

Here, an excessively large distance L between the electrode portions 25a and 25b weakens an electric field when the lamp voltage is equal, so that the initial electrons cannot be accelerated sufficiently. As a result, the initial electrons may collide with the mercury atoms and cannot obtain an energy necessary for emitting the secondary electrons, so that the ionization process cannot be facilitated sufficiently. Therefore, it is preferable that the distance L (mm) satisfies L≦55 regardless of the rated power.

### EMBODIMENT 2

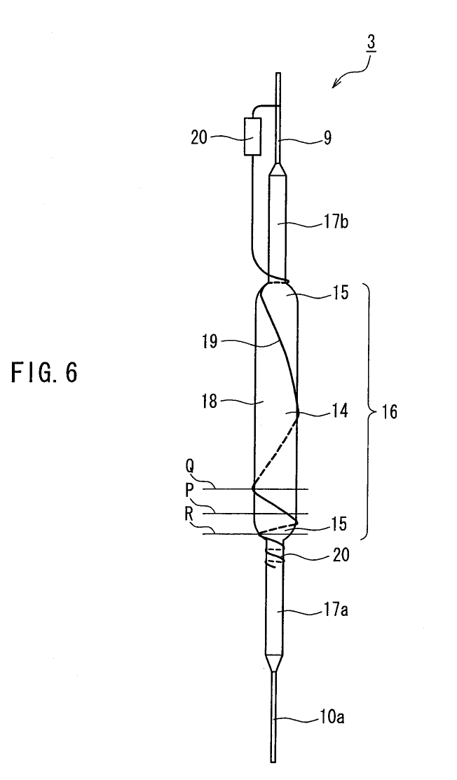

The following is a description of a metal halide lamp according to Embodiment 2 of the present invention, with reference to FIGS. 5 and 6. In a metal halide lamp 1 with a rated lamp power of 150 W in the present embodiment, 2 turns of a proximity conductor 19 are wound helically around and in close contact with an outer surface of a main tube portion 16, and in particular, at least 0.5 turn of the proximity conductor 19 is wound helically around and in close contact with a predetermined end region of the outer surface of the main tube portion 16. Other configurations are similar to those of the metal halide lamp 1 with the rated lamp power of 150 W in Embodiment 1 described above.

The “predetermined end region of the main tube portion 16” refers to a region sandwiched between a plane Q (a second plane) and a plane R (a third plane). The plane Q and the plane R are defined as follows.

First, a plane that includes a tip of a first electrode portion 25a located on a side of a first slender tube portion 17a where a first helical portion 19a is located and is orthogonal to a center axis X of a discharge tube 3 in its longitudinal direction is defined as a plane P (a first plane). The plane Q is defined as a plane that is parallel with the plane P and spaced by 5 mm from this plane P toward a second electrode portion 25b. The plane R is defined as a plane that is parallel with the plane P and, in a cross-section of the discharge tube 3 taken along a plane including the center axis X (see FIG. 5), includes a point of change A at which a straight line portion of an inner surface of the first slender tube portion 17a extending from an end opposite to the main tube portion 16 out of both ends of the first slender tube portion 17a toward the main tube portion 16 changes to a curved portion of an inner surface of a hemispherical portion 15 (see FIG. 5).

The position of this point of change A varies diversely depending on the inner shape of the main tube portion 16. Usually, since in the cross-section of the discharge tube 3 taken along the plane including the center axis X, the inner surface of the first slender tube portion 17a is indicated by a substantially straight line, the point of change A corresponds to a point at which this straight line extending straight toward the main tube portion 16 starts changing to another straight line or a curve. For example, when the inner surface of the hemispherical portion 15 and the inner surface of the first slender tube portion 17a are connected by a curve having a predetermined curvature r, a boundary point between the straight line of the inner surface of the first slender tube portion 17a and the curve having the curvature r corresponds to the point of change A.

In the example illustrated in FIG. 5, the proximity conductor 19 is a coil of 1 turn starting from the point where the proximity conductor 19 crosses the plane R and ending at the point where it crosses the plane Q in the end region of the main tube portion 16.

Incidentally, in the case of the coil of at least 1 turn, it is appropriate that the coiling pitch exceeds 100%.

Further, in terms of the restarting characteristics, there is no particular limitation on the number of turns of a portion of the proximity conductor 19 wound around the main tube portion 16 other than the end region of the main tube portion 16. The proximity conductor 19 does not have to be wound, or plural turns of the proximity conductor 19 may be wound. However, since a large number of turns of the proximity conductor 19 block light irradiated from the discharge tube 3, a fewer number of turns are more preferable. In the example illustrated in FIG. 6, in order to wind the proximity conductor 19 naturally without any special processing when winding the proximity conductor 19 around the other slender tube portion 17b, 1 turn of the proximity conductor 19 is wound around the portion other than the end region.

The following description will be directed to results of an experiment conducted for confirming an effect produced by the configuration of the metal halide lamp with a rated lamp power 150 W according to the present embodiment.

10 samples of this metal halide lamp were produced in which the amount of sealed mercury was 1.84 mg/cm³ (the total amount was 0.8 mg) and the number of turns of the first helical portion 19a was 2. Then, after individual lamps produced as above were operated continuously for 1 hour by a usual method using the above-mentioned electronic ballast, they were turned off and restarted. The restarting time from immediately after turning off (a power) until restarting was measured. The results of the experiment follow.

The average restarting time was 8.2 seconds, which was equal to or shorter than ⅓ of that of the metal halide lamp 1 with the rated lamp power of 150 W according to Embodiment 1 of the present invention.

It should be noted that the shortest restarting time of the samples was 1.0 second.

When the lamp was observed visually at the time of restarting, the metal halide lamp with the rated lamp power of 150 W according to Embodiment 2 showed a phenomenon different from the metal halide lamp with the rated lamp power of 150 W according to Embodiment 1.

That is, in the case of the metal halide lamp according to Embodiment 1, after a light emission of an arc discharge was observed via the main tube portion 16 between the first electrode portion 25a and, for example, an arbitrary point (a point a) of the proximity conductor 19 present between the plane P and the plane Q, it instantly (0.5 seconds) shifted to a dielectric breakdown between the electrode portions 25a and 25b. On the other hand, in the case of the metal halide lamp with the rated lamp power of 150 W according to Embodiment 2, the following was found. Similarly to the lamp in Embodiment 1, after a light emission of an arc discharge was observed via the main tube portion 16 between the first electrode portion 25a and, for example, an arbitrary point (a point a, not shown) of the proximity conductor 19 present between the plane P and the plane Q, the arc discharge successively shifted to an arc discharge between the first electrode portion 25a and a point b (not shown) of the proximity conductor 19 on the side of the second electrode portion 25b with respect to the point a. Further, this shifting occurs successively to the vicinity of the electrode portion 25b of the proximity conductor 19 and then is shifted to a dielectric breakdown between the electrode portions 25a and 25b. This took 0.2 to 0.5 seconds.

In other words, in the case of the metal halide lamp 1 with the rated lamp power of 150 W according to Embodiment 1 of the present invention, although the arc discharge was generated between the first electrode portion 25a and the point a via the main tube portion 16, it sometimes did not shift to the dielectric breakdown between the electrode portions 25a and 25b. In contrast, in the case of the metal halide lamp with the rated lamp power of 150 W according to Embodiment 2 of the present invention, it is considered that the arc discharge generated between the first electrode portion 25a and the point a via the main tube portion 16 was guided to the vicinity of the second electrode portion 25b by the proximity conductor 19 and shifted to the dielectric breakdown between the electrode portions 25a and 25b with a high probability.

Thus, the configuration of the metal halide lamp 1 with the rated lamp power of 150 W according to Embodiment 2 makes it possible to achieve a more reliable restarting compared with the metal halide lamp 1 with the rated lamp power of 150 W according to Embodiment 1, so that the restarting characteristics can be improved far more considerably.

Moreover, it was confirmed that the result described above also was obtained even in the case of applying a high frequency voltage of 3.0 kV maximum, for example. Thus, at least by applying a high frequency voltage of 3.0 kV maximum, the above-described effect can be obtained reliably. However, as the voltage to be applied becomes larger, the restarting characteristics are considered to improve further.

Incidentally, although Embodiment 2 has been directed to the case in which the amount of sealed mercury was 1.84 mg/cm³ and the number of turns of the first helical portion 19a was 2, the effect similar to the above can be obtained as long as the amount of sealed mercury is equal to or smaller than 2.5 mg/cm³ and the number of turns of the first helical portion 19a was 2 or more.

Incidentally, although Embodiments 1 and 2 have been directed to the case where the first helical portion 19a is wound on the side of the first slender tube portion 17a and the proximity conductor 19 is connected electrically to the second electrode portion 25b located on the side of the second slender tube portion 17b, the proximity conductor 19 may be attached reversely. In other words, in the case where the first helical portion 19a is wound on the side of the second slender tube portion 17b and the proximity conductor 19 is connected electrically to the first electrode portion 25a located on the side of the first slender tube portion 17a, the effect similar to the above also can be obtained.

Further, although Embodiments 1 and 2 have been illustrated the metal halide lamp with the rated power of 150 W, there is no limitation to this. The present invention similarly can be applied further to metal halide lamps with a rated power of 35 to 400 W such as those of 100 W and 250 W.

### EMBODIMENT 3

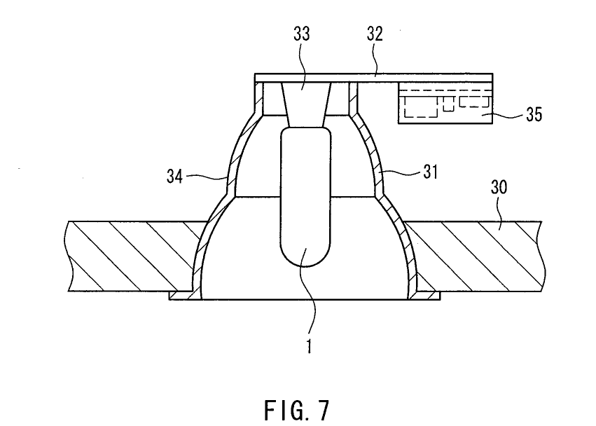

An illuminating device according to Embodiment 3 of the present invention will be described, with reference to FIG. 7. This illuminating device is used for a ceiling light, for example, and includes a luminaire 34, the metal halide lamp 1 with a rated power of 150 W according to Embodiment 1 of the present invention and an electronic ballast 35. The luminaire 34 has an umbrella-shaped reflecting lighting fixture 31 built into a ceiling 30, a plate-shaped base portion 32 attached to a bottom of the reflecting lighting fixture 31, and a socket portion 33 provided inside the reflecting lighting fixture 31 on the bottom. The metal halide lamp 1 is attached to the socket portion 33 inside this luminaire 34. The electronic ballast 35 is attached to a position in the base portion 32 away from the reflecting lighting fixture 31.

The electronic ballast 35 can be a known electronic ballast. If a magnetic ballast, which is in general use as a ballast, is used, the lamp power varies due to a fluctuation of a power supply voltage. Thus, when the power supply voltage increases, the lamp power may exceed the rated power, so that the temperature of an outer surface of a discharge tube (not shown) rises, thus causing ceramics constituting an envelope of the discharge tube to be scattered. In contrast, in the case of using the electronic ballast 35, since the lamp power can be kept constant over a wide voltage range, it is possible to control the temperature of the outer surface of the discharge tube at a constant level, thereby reducing the possibility that the ceramics constituting the envelope of the discharge tube may be scattered.

As described above, with the configuration of the illuminating device according to Embodiment 3 of the present invention, since the metal halide lamp according to Embodiment 1 is used, it is possible to improve the restarting characteristics considerably.

Incidentally, Embodiment 3 has illustrated an exemplary case in which the illuminating device is used for a ceiling light. However, the illuminating device also can be used for other indoor illumination, store illumination, street illumination and the like without any particular limitation. Further, various known luminaries and electronic ballasts can be used according to the intended purposes.

In addition, although Embodiment 3 has been directed to the case of using the metal halide lamp according to Embodiment 1, the effect similar to the above also can be obtained in the case of using any metal halide lamps according to the present invention.

### INDUSTRIAL APPLICABILITY

The metal halide lamp according to the present invention is useful for illumination requiring excellent restarting characteristics.

1. A metal halide lamp comprising:
a discharge tube comprising
an envelope that is formed of a translucent ceramic and has a main tube portion and a first slender tube portion and a second slender tube portion respectively formed in both end portions of the main tube portion,
a first electrode lead-in member having a first electrode portion formed in its tip portion, and
a second electrode lead-in member having a second electrode portion formed in its tip portion;
wherein the first electrode lead-in member is inserted in the first slender tube portion so that a tip portion of the first electrode portion is located in the main tube portion, and the first electrode lead-in member is sealed in an end portion of the first slender tube portion on a side opposite to the main tube portion,
the second electrode lead-in member is inserted in the second slender tube portion so that a tip portion of the second electrode portion is located in the main tube portion, and the second electrode lead-in member is sealed in an end portion of the second slender tube portion on a side opposite to the main tube portion,
a gap is formed respectively between the slender tube portion and the electrode lead-in member,
a proximity conductor is provided on an outer surface of the discharge tube, at least 2 turns of part of the proximity conductor are wound helically around an end portion of the first slender tube portion on a side of the main tube portion, and the proximity conductor is connected electrically to the second electrode portion, and
an amount of sealed mercury in the discharge tube is equal to or smaller than 2.5 mg/cm³.

2. The metal halide lamp according to claim 1, wherein at least 0.5 turn of the proximity conductor is wound helically around an outer surface of the main tube portion over an entire end region of the main tube portion sandwiched by a second plane and a third plane,
where a first plane is defined as a plane that includes a tip of the first electrode portion and is orthogonal to a center axis of the discharge tube in its longitudinal direction,
the second plane is defined as a plane that is parallel with the first plane and spaced by 5 mm from the first plane toward the second electrode portion, and
the third plane is defined as a plane that is parallel with the first plane and, in a cross-section of the discharge tube taken along a plane including the center axis, includes a point of change at which a straight line portion of an inner surface of the first slender tube portion extending from an end opposite to the main tube portion out of both ends of the first slender tube portion toward the main tube portion changes to another straight line or a curve.

3. An illuminating device comprising a luminaire, and the metal halide lamp according to claim 1 built into the luminaire.
